(19) United States
(12) Patent Application Publication
(10) Pub. No.: US 2020/0260900 A1
(43) Pub. Date: Aug. 20, 2020

(54) WIRELESS INDUCTION HEATING COOKER AND WIRELESS INDUCTION HEATING SYSTEM COMPRISING THE SAME

(71) Applicant: LG Electronics Inc., Seoul (KR)

(72) Inventors: Wan Soo KIM, Seoul (KR); Hyeunsik NAM, Seoul (KR); Byungkyu PARK, Seoul (KR); Yangkyeong KIM, Seoul (KR)

(21) Appl. No.: 16/796,689

(22) Filed: Feb. 20, 2020

(30) Foreign Application Priority Data
Feb. 20, 2019 (KR) 10-2019-0020142
Nov. 19, 2019 (KR) 10-2019-0148580

(51) Int. Cl. A47J 27/086; H05B 6/12; H05B 3/00; F24C 7/08; A47J 27/08; H02J 50/12; H02J 50/40

(52) U.S. Cl. CPC A47J 27/086; H05B 6/1209; H05B 6/1236; H05B 3/0014; H05B 6/1245; H05B 2213/06; H05B 6/12; A47J 27/0802; H02J 50/12; H02J 50/40; F24C 7/087

(57) ABSTRACT

A wireless induction heating system includes an induction heating device having a heating coil configured to generate a magnetic field and a wireless induction heating cooker disposed in an area formed by the heating coil and configured to perform cooking operation based on the magnetic field generated by the heating coil. The induction heating device and the wireless induction heating cooker can perform mutual data communication to control output of the heating coil and output abnormality information, based on a displacement state of the wireless induction heating cooker with respect to the induction heating device.

### CROSS-REFERENCE TO RELATED APPLICATIONS

The present disclosure claims priority to and the benefit of Korean Patent Application No. 10-2019-0020142, filed on Feb. 20, 2019 and Korean Patent Application No. 10-2019-0148580, filed on Nov. 19, 2019, the disclosures of which are incorporated herein by reference in their entireties.

### BACKGROUND

### 1. Technical Field

The present disclosure relates to a wireless induction heating system including an induction heating device and a wireless induction heating cooker that perform mutual data communication to determine optimal displacement of the wireless induction heating cooker relative to the induction heating device to perform improved heat transfer.

### 2. Description of Related Art

Some cooking devices use a wireless induction heating method. For example, food is heated using a magnetic field generated by an induction heating device, rather than using direct heat.

Some electric cookers heat food using an induction heating method. An example of such electric cookers is illustrated in FIG. 1. As illustrated in FIG. 1, an existing electric cooker 100′ includes an inner pot 30′ received in an inner pot holder 14′ and an induction heating coil 15′ that heats the inner pot 30′ at a bottom portion of the inner pot holder 14′. A heating power receiving coil 16′ is provided on a bottom surface of a body 12′ of a rice cooker 10′ to receive power from a power supply 20′ and supply the power to the induction heating coil 15′. In the electric cooker 100′, induction current is generated by the heating power receiving coil 16′ based on the magnetic field generated by a heating power supply coil 23′ provided in the power supply 20′. Further, induction current is generated in the induction heating coil 15′ by the magnetic field generated by the heating power receiving coil 16′ and used to heat an inner pot 30′.

However, this configuration requires a first power transmitting process between the heating power supply coil 23′ and the heating power receiving coil 16′ and a second power transmitting process between the heating power receiving coil 16′ and the induction heating coil 15′ in order to heat the inner pot 30′, thereby increasing power (or heat) loss during such two power transmitting processes.

In addition, some electric cookers can include various types of electronic devices that need to be powered. However, the electric cooker 100′ merely discloses a process of heating the inner pot 30′ using the magnetic field generated by the heating power supply coil 23′ and does not consider powering various types of electronic devices built in the cooker 100′ using, for example, the power supply 20′.

### SUMMARY

The present disclosure provides a wireless induction heating system capable of determining whether a wireless induction heating cooker is properly positioned on an induction heating device.

The present disclosure further provides a wireless induction heating system that informs users that the wireless induction heating cooker is abnormally positioned on the induction heating device.

The present disclosure also provides a wireless induction heating system that controls an amount of heat transferred to the wireless induction heating cooker based on a displacement state of the wireless induction heating cooker relative to the induction heating device.

The advantages of the present disclosure are not limited to those mentioned herein, and other advantages of the present disclosure can be understood by the implementations of the present disclosure described herein.

Particular embodiments described herein include a wireless induction heating system including an induction heating device and a wireless induction heating cooker. The induction heating device may include a heating coil defining a heating area and configured to generate a magnetic field. The wireless induction heating cooker may be configured to be positioned on the heating area of the induction heating device, and configured to perform a cooking operation using the magnetic field generated by the heating coil. The induction heating device and the wireless induction heating cooker may be configured to perform data communication with each other and control output of the heating coil based on a position of the wireless induction heating cooker relative to the induction heating device. The induction heating device and the wireless induction heating cooker may be configured to output abnormality information based on the position of the wireless induction heating cooker being an abnormal position.

In some implementations, the system can optionally include one or more of the following features. The induction heating device may be configured to determine a displacement state of the wireless induction heating cooker based on a change in an amount of current through the heating coil. Based on the change in the amount of current through the heating coil being equal to or less than a reference value, the induction heating device may determine the displacement state of the wireless induction heating cooker to be a normal displacement state. Based on the change in the amount of current through the heating coil exceeding the reference value, the induction heating device may determine the displacement state of the wireless induction heating cooker to be an abnormal displacement state. The induction heating device may be configured, based on the displacement state of the wireless induction heating cooker being a normal displacement state, to maintain the output of the heating coil. The induction heating device may be configured, based on the displacement state of the wireless induction heating cooker being an abnormal displacement state, to reduce the output of the heating coil. The wireless induction heating cooker may be configured to perform the data communication with the induction heating device based on current induced by the magnetic field generated by the heating coil. The induction heating device may be configured to determine a communication state with the wireless induction heating cooker based on the wireless induction heating cooker being an abnormal displacement state relative to the induction heating device. The induction heating device may be configured to generate abnormality information and control the wireless induction heating cooker to output the abnormality information based on the communication state with the wireless induction heating cooker. The wireless induction heating cooker may be configured, based on the communication state between the induction heating device and the wireless induction heating cooker being a normal state, to output the abnormality information. The induction heating device may be configured, based on the communication state between the induction heating device and the wireless induction heating cooker being an unable state, to reduce the output of the heating coil and output the abnormality information. The wireless induction heating cooker may include a receiving coil in which current is induced based the magnetic field generated by the heating coil. The wireless induction heating cooker may be configured to determine a displacement state of the wireless induction heating cooker relative to the induction heating device based on a change in an amount of current through the receiving coil. Based on the change in the amount of current through the receiving coil being equal to or less than a reference value, the wireless induction heating cooker may determine the displacement state of the wireless induction heating cooker to be a normal displacement state. Based on the change in the amount of current through the receiving coil exceeding the reference value, the wireless induction heating cooker may determine the displacement state of the wireless induction heating cooker to be an abnormal displacement state. The wireless induction heating cooker may be configured to output an abnormal signal based on the displacement state of the wireless induction heating cooker being an abnormal displacement state. The wireless induction heating cooker may be configured to transmit an output reduction request signal to the induction heating device based on the displacement state of the wireless induction heating cooker being an abnormal displacement state. The induction heating device may be configured to reduce the output of the heating coil based on the output reduction request signal. The wireless induction heating cooker may include a communicator and an internal battery configured to supply power to the communicator. The wireless induction heating cooker may be configured to transmit the output reduction request signal to the induction heating device through the communicator.

Particular embodiments described herein include a wireless induction heating cooker. The wireless induction heating cooker may be configured to operate on an induction heating device having a heating coil. The wireless induction heating cooker may include a main body, a lid, an inner pot, a first power receiving coil, a side heating coil, a power transmitting coil, a second power receiving coil, a controller, and a communicator. The main body may have an upper surface defining an opening. The lid may be configured to cover the upper surface of the main body and include a plurality of electronic devices. The inner pot may be received in the main body and heated using a first magnetic field generated by the heating coil of the induction heating device. The first power receiving coil may be disposed on a bottom surface of the main body. Current may be induced in the first power receiving coil based on the first magnetic field generated by the heating coil. The side heating coil may be disposed around an outer side surface of the inner pot. The side heating coil may be connected to the first power receiving coil and configured to heat the inner pot based on the current induced in the first power receiving coil. The power transmitting coil may be disposed at a side of the main body and configured to receive the current induced in the first power receiving coil and generate a second magnetic field. The second power receiving coil may be disposed at a side of the lid and configured to supply a current to one or more of the plurality of electronic devices. The current may be induced by the second magnetic field generated by the power transmitting coil. The controller may be configured to determine an displacement state of the wireless induction heating cooker relative to the induction heating device based on a change in an amount of current through at least one of the first power receiving coil and the second power receiving coil. The communicator may be configured to perform data communication with the induction heating device based on the displacement state of the wireless induction heating cooker.

In some implementations, the system can optionally include one or more of the following features. The controller and the communicator may be configured to operate based on the current induced in the second power receiving coil. The controller may be configured to, based on the change in the amount of current being equal to or less than a reference value, determine the displacement state of the wireless induction heating cooker as a normal displacement state. The controller may be configured to, based on the change in the amount of current exceeding the reference value, determine the displacement state of the wireless induction heating cooker as an abnormal displacement state. The controller may be configured to visually output abnormality information based on determination that the displacement state of the wireless induction heating cooker is the abnormal displacement state. The communicator may be configured to transmit an output reduction request signal to the induction heating device based on determination that displacement state of the wireless induction heating cooker is an abnormal displacement state. The induction heating device may be configured to reduce the output of the heating coil based on the output reduction request signal. The communicator may be configured to transmit the output reduction request signal based on the current induced in the second power receiving coil or power supplied by an internal battery. The communicator may be configured to receive an abnormality information output request signal from the induction heating device based on determination that the displacement state of the wireless induction heating cooker is an abnormal displacement state. The controller may be configured to visually output abnormality information based on the abnormality information output request signal. The one or more of the plurality of electronic devices may include the controller and the communicator, and are disposed at the lid.

According to some implementations of the present disclosure, the wireless induction heating system may detect a change in the amount of current through the heating coil of the induction heating device and may determine whether the wireless induction heating cooker is normally or properly disposed on the induction heating device.

In some examples, the wireless induction heating system may output abnormality information through at least one of the wireless induction heating cooker and the induction heating device when the wireless induction heating cooker is abnormally positioned on the induction heating device, so that a user is informed of the abnormally positioned wireless induction heating cooker relative to the induction heating device.

In some examples, the wireless induction heating system may control output of the heating coil based on a displacement state of the wireless induction heating cooker to control an amount of heat transferred to the wireless induction heating inner pot.

According to some implementations of the present disclosure, the wireless induction heating system may determine whether the wireless induction heating cooker is normally positioned on the induction heating device and identify poor displacement of the wireless induction heating cooker, which would cause degraded rice-cooking performance without user's recognition.

In some examples, the wireless induction heating system may notify the user of the wireless induction heating cooker abnormally positioned on the induction heating device, thereby allowing the user to properly position the wireless induction heating cooker on the induction heating device and preventing degradation in the rice-cooking performance that may result from the poor displacement of the wireless induction heating cooker.

In some examples, the wireless induction heating system may control the amount of heat transferred to the wireless induction heating cooker based on the mutual displacement state between the wireless induction heating cooker and the induction heating device, thereby preventing safety problems that may result from the poor displacement of the wireless induction heating cooker.

### BRIEF DESCRIPTION OF THE DRAWINGS

FIG. 1 is a side cross-sectional view of an electric cooker in related art.

FIG. 2 shows an example wireless induction heating cooker that operates on an induction heating device.

FIG. 3 is a side cross-sectional view of the wireless induction heating cooker shown in FIG. 2.

FIGS. 4A and 4B respectively show example displacement of a first power receiving coil.

FIG. 5 is an enlarged view of a power transmitting coil and a second power receiving coil shown in FIG. 2.

FIG. 6 shows an example control flow of a wireless induction heating cooker operating on an induction heating device.

FIG. 7 shows an example wireless induction heating system.

FIG. 8 shows an example control flow of the wireless induction heating system shown in FIG. 7.

FIG. 9 is a flowchart of an example process of operating an induction heating device.

FIG. 10 is a flowchart of an example process of operating a wireless induction heating cooker.

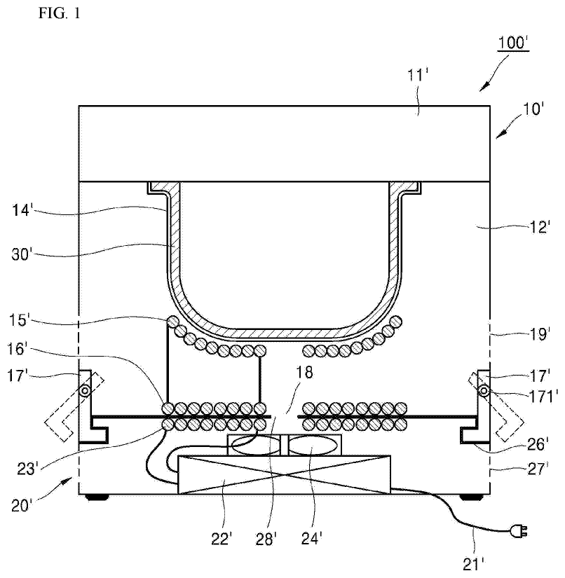

### DETAILED DESCRIPTION OF EXEMPLARY EMBODIMENTS

Some implementations of the present disclosure are described in detail with reference to the accompanying drawings. A detailed description of a well-known technology relating to the present disclosure may be omitted if it unnecessarily obscures the gist of the present disclosure. Same reference numerals can be used to refer to same or similar components.

In this document, the terms “upper,” “lower,” “on,” “under,” or the like are used such that, where a first component is arranged at “an upper portion” or “a lower portion” of a second component, the first component may be arranged in contact with the upper surface or the lower surface) of the second component, or another component may be disposed between the first component and the second component. Similarly, where a first component is arranged on or under a second component, the first component may be arranged directly on or under (in contact with) the second component, or one or more other components may be disposed between the first component and the second component.

Further, the terms “connected,” “coupled,” or the like are used such that, where a first component is connected or coupled to a second component, the first component may be directly connected or able to be connected to the second component, or one or more additional components may be disposed between the first and second components, or the first and second components may be connected or coupled through one or more additional components.

In general, the present disclosure relates to a wireless induction heating system including an induction heating device and a wireless induction heating cooker which can mutually communicate to achieve optimal displacement of the heating cooker relative to the heating device for heat transfer.

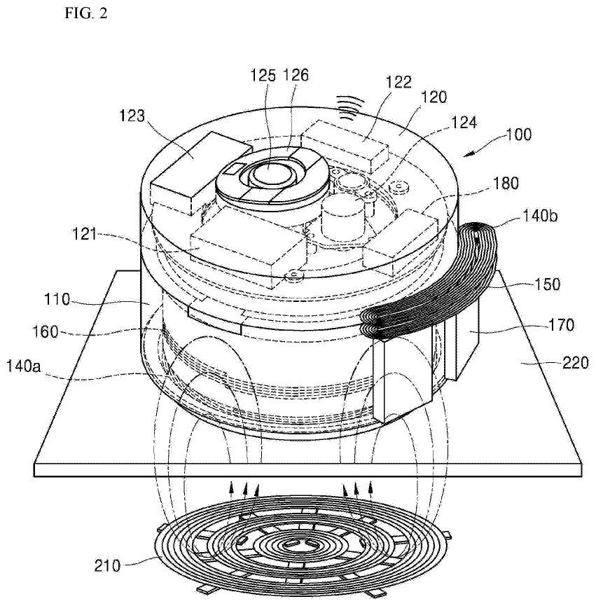

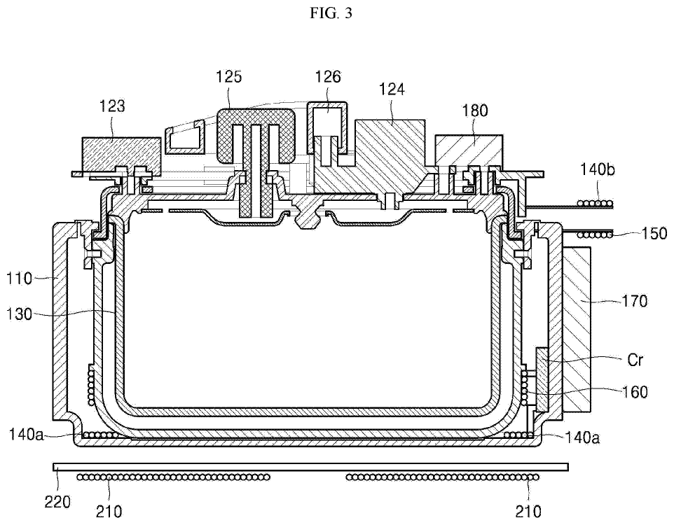

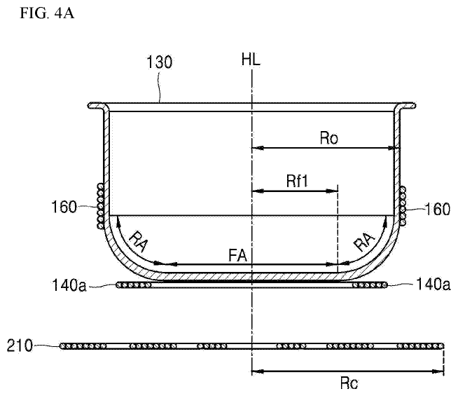

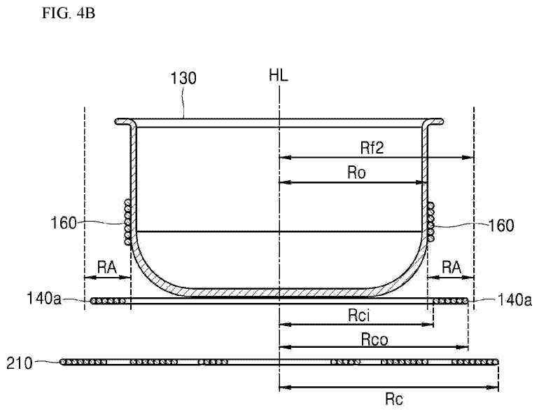

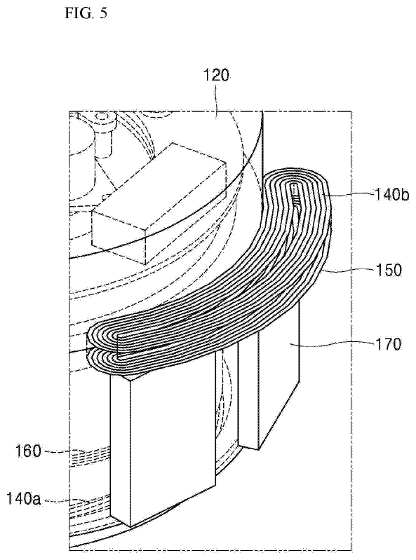

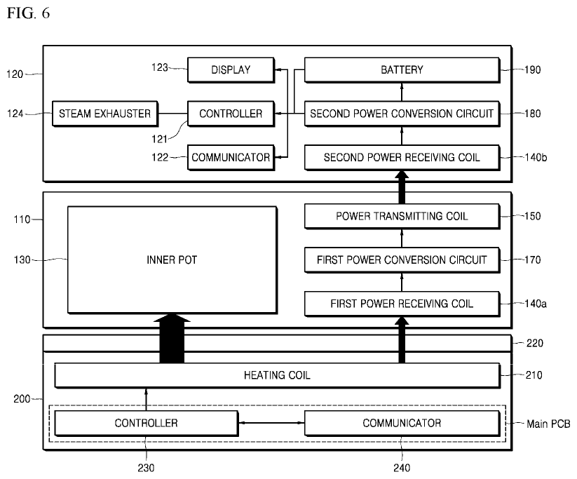

Referring to FIGS. 2-6, an example wireless induction heating cooker according to some implementations of the present disclosure is described. FIG. 2 shows an example wireless induction heating cooker that operates on an induction heating device. FIG. 3 is a side cross-sectional view of the wireless induction heating cooker shown in FIG. 2. FIGS. 4A and 4B respectively show example displacement of a first power receiving coil. FIG. 5 is an enlarged view of a power transmitting coil and a second power receiving coil shown in FIG. 2. FIG. 6 shows an example control flow of a wireless induction heating cooker that operates on an induction heating device.

In some implementations, the wireless induction heating cooker of the present disclosure can be disposed on the induction heating device and perform cooking operation using a magnetic field generated by the heating coil of the induction heating device.

Referring to FIGS. 2 and 3, in some implementations, a wireless induction heating cooker 100 includes a main body 110, a lid 120, an inner pot 130, a first power receiving coil 140a, a power transmitting coil 150, a side heating coil 160, and a second power receiving coil 140b. The lid 120 includes a controller 121, a communicator 122, a display 123, a steam exhauster 124, a pressure weight 125, and a noise reducer 126. The wireless induction heating cooker 100 can include additional components that are not illustrated in FIGS. 2 and 3, with or without one or more of the illustrated components of the wireless induction heating cooker 100 being removed or modified as desired.

In some implementations, the wireless induction heating cooker 100 may operate on any induction heating device configured to heat an object through electromagnetic induction.

As shown in FIG. 2 and FIG. 3, the wireless induction heating cooker 100 may operate while being placed on a top plate 220 of an induction heating device that includes a heating coil 210. In some examples, the wireless induction heating cooker 100 may operate while being placed on the top plate 220 and arranged vertically above the heating coil 210.

A main printed circuit board (PCB) of the induction heating device can control current that flows through the heating coil 210 so that the heating coil 210 generates a magnetic field. The magnetic field generated by the heating coil 210 may induce current in the inner pot 130 and the first power receiving coil 140a described below.

In some implementations, the main body 110 may be configured to support a lower portion and a side portion of the wireless induction heating cooker 100. For example, the main body 110 may have a cylindrical shape with an open top. Food items may be cooked inside the main body 110. In some examples, the main body 110 can received the inner pot 130. Various types of grains such as rice may be heated and cooked in the inner pot 130 received in the main body 110.

The lid 120 is configured to seal an upper portion of the wireless induction heating cooker 100 and may be fastened to an upper surface of the main body 110. For example, the lid 120 may be fastened to the main body 110 and configured to be opened and closed with respect to the upper surface of the main body 110.

In one example, the lid 120 may be coupled to the main body 110 using a hinge so that the lid 120 can be selectively opened and closed. In some examples, the lid 120 is coupled to a hinge shaft provided on the upper surface of the main body 110, and may be selectively opened and closed with respect to the upper surface of the main body 110 as the lid 120 is rotated about the hinge shaft.

In another example, the lid 120 may be detachably coupled to the main body 110. In some examples, the lid 120 may be coupled to the upper surface of the main body 110 by a plurality of fastening members at an upper edge of the main body 110. For example, the lid 120 can be completely separated from the main body 110. The lid 120 that is completely removed from the main body 110 can be easily cleaned.

In some examples, as shown in FIGS. 2 and 3, the lid 120 may include at least one electronic device. For example, the lid 120 includes a controller 121 that controls overall operation of the wireless induction heating cooker 100, a communicator 122 that performs data communication with the induction heating device, and a display 123 that visually outputs state information related to the wireless induction heating cooker 100. In some examples, the lid 120 may further include a battery that supplies power to the controller 121, the communicator 122, the display 123, and/or any other suitable electronic devices in the lid 120.

In some implementations, the controller 121, the communicator 122, and the display 123 may be implemented with a printed circuit board (PCB) including a plurality of integrated circuits (ICs).

In some examples, the lid 120 may include a pressure weight 125 configured to maintain a constant internal pressure of the wireless induction heating cooker 100. The lid 120 can include a noise reducer 126, which may include a sound absorbing member, to reduce noise during exhaust of steam. In some examples, the lid 120 may include a steam exhauster 124 (e.g., a solenoid valve) configured to exhaust the internal steam of the wireless induction heating cooker 100 out of the wireless induction heating cooker 100. The steam exhauster 124 can be operated based on a specific control signal, such as a control signal output by the controller 121.

The inner pot 130 may be received in the main body 110 and heated by a magnetic field generated by the heating coil 210 of the induction heating device. The inner pot 130 may have a shape corresponding to an inner storage space of the main body 110. For example, in some cases where the main body 110 has a cylindrical shape, the inner pot 130 may also have a cylindrical shape with an open upper surface.

When the wireless induction heating cooker 100 is placed on the induction heating device, the lower surface of the inner pot 130 and the heating coil 210 may be opposed to each other and the bottom surface of the main body 110 may be disposed between the lower surface of the inner pot 130 and the heating coil 210. When current flows through the heating coil 210, a magnetic field is generated around the heating coil 210 and may induce current in the inner pot 130, so that Joule's heat may be generated in the inner pot 130 based on the induced current.

In order to generate the induced current, the inner pot 130 may be made of magnetic material. For example, the inner pot 130 may be made of a cast iron containing iron (Fe). In addition or alternatively, the inner pot 130 may be made of a clad in which iron (Fe), aluminum (Al), stainless steel, and/or other suitable materials are bonded.

In some examples, a width of the bottom surface of the inner pot 130 may be narrower than a width of the heating coil 210. In other words, where the heating coil 210 is a circular plate coil and the inner pot 130 has a cylindrical shape, a radius of the bottom surface of the circular inner pot 130 may be smaller than a coil radius (Rc), which is a distance between a center of the heating coil 210 and an outer circumferential surface of the heating coil 210. In some cases where the width of the bottom surface of the inner pot 130 is narrower than the width of the heating coil 210, all of the magnetic fields generated by the heating coil 210 may be transmitted onto the bottom surface of the inner pot 130 without leakage in an area where the inner pot 130 is disposed.

In some implementations, the first power receiving coil 140a may be provided on the bottom surface of the main body 110. Current may be induced in the first power receiving coil 140a based on a magnetic field generated by the heating coil 210.

The first power receiving coil 140a may be configured to be in a ring shape having a predetermined inner diameter and a predetermined outer diameter. The first power receiving coil 140a may be provided at any position of the bottom surface of the main body 110. In some implementations, in order to maximize a heating efficiency of the inner pot 130 due to an electromagnetic induction phenomenon, the first power receiving coil 140a is preferably disposed in parallel with the heating coil 210 at the lower portion of an edge region of the inner pot 130.

The edge region may be a region defined in a radial direction with respect to a center vertical line of the inner pot 130, and may be an area adjacent to a cylindrical surface of the inner pot 130. In other words, the edge region may be adjacent to a circumference of the inner pot 130 when the inner pot 130 is viewed from the top. The edge region of the inner pot 130 is described below in detail with reference to FIGS. 4A and 4B.

Referring to FIG. 4A, the bottom surface of the inner pot 130 may include a plate area FA parallel to the heating coil 210 and an edge area RA connecting the plate area FA and a side surface of the inner pot 130.

A corner (hereinafter, the rounding portion RA) of the bottom surface of the inner pot 130 may be rounded to facilitate removal of the food after completion of cooking of the food. Accordingly, the bottom surface of the inner pot 130 may include a plate panel area FA that is flat and in parallel with the heating coil 210 and a rounding portion RA rounded to connect the bottom surface of the inner pot 130 and the side surface of the inner pot 130.

In one example, the edge area RA of the inner pot 130 may be a rounding portion RA, as shown in FIG. 4A. In this example, the first power receiving coil 140a may be disposed in the horizontal direction below the edge area RA of the inner pot 130, that is, below the rounding portion RA.

In more detail, the plate area FA of the bottom surface of the inner pot 130 may be formed within a first reference radius Rf1 with respect to the center vertical line HL of the inner pot 130, and the edge area RA of the inner pot 130 may be formed between the first reference radius Rf1 and the outer diameter Ro of the inner pot 130.

In this structure, the first power receiving coil 140a may be disposed between the first reference radius Rf1 and the outer diameter Ro of the inner pot 130. In other words, a horizontal displacement range of the first power receiving coil 140a may be a range between the first reference radius Rf1 and the outer diameter Ro of the inner pot 130.

Referring back to FIG. 4A, in embodiments that a distance between the edge area RA and the heating coil 210 is greater than a distance between the plate area FA and the heating coil 210, an amount of heat that is caused by a magnetic field generated by the heating coil 210 and transferred to the edge area RA may be relatively less than an amount of heat that is caused by the magnetic field generated by the heating coil 210 and transferred to the plate area FA. Therefore, the first power receiving coil 140a that is disposed below the edge area RA can operate to permit for the edge area RA to receive the power from the heating coil 210 without significantly losing a total amount of transferred heat with respect to the inner pot 130.

In other examples, referring to FIG. 4B, the edge area RA of the inner pot 130 may be vertically formed outside the inner pot 130. In some examples, the edge area RA of the inner pot 130 may be formed between the outer diameter Ro of the inner pot 130 and the second reference radius Rf2.

Accordingly, the first power receiving coil 140a may be vertically disposed outside the inner pot 130. In other words, the first power receiving coil 140a may have an inner diameter Rci of the first power receiving coil 140a greater than an outer diameter Ro of the inner pot 130 and may be disposed under the inner pot 130.

However, in order to efficiently generate induced current in the first power receiving coil 140a, the outer diameter Rco of the first power receiving coil 140a may be less than the coil radius Rc of the heating coil 210.

In other words, as shown in FIG. 4B, the inner diameter Rci of the first power receiving coil 140a is greater than the outer diameter Ro of the inner pot 130, and the outer diameter Rco of the first power receiving coil 140a is less than the coil radius Rc of the heating coil 210, and thus, an area formed by the first power receiving coil 140a may all be vertically disposed relative to the area formed by the heating coil 210. Accordingly, in the example shown in FIG. 4B, the magnetic field generated by the heating coil 210 may be transmitted to the first power receiving coil 140a without leakage in the area where the first power receiving coil 140a is disposed.

In some implementations, the first power receiving coil 140a is disposed under the edge area where heat conduction is not provided vertically to the inner pot 130. The first power receiving coil 140a is configured and arranged to receive the power from the heating coil 210 so that the amount of heat transferred to the inner pot 130 is not degraded.

According to the present disclosure, some implementations of the wireless induction heating cooker use a magnetic field that is generated in the region of low heat transfer efficiency with respect to the inner pot, as a power source of one or more internal electronic devices. Use of the magnetic field generated in the region of low heat transfer efficiency as a power source of the internal electronic devices can improve efficiency in using the power supplied wirelessly from the induction heating device for the cooking operation.

In some examples, a side heating coil 160 is vertically disposed on the outer circumferential surface of the inner pot 130. The side heating coil 160 can be connected to the first power receiving coil 140a to heat the inner pot 130 based on the current induced in the first power receiving coil 140a.

Referring to FIGS. 2 and 3, the side heating coil 160 may be wound around the outer circumferential surface of the inner pot 130 and may be in contact with the outer circumferential surface of the inner pot 130. In some cases, an inner pot support member may be provided in the main body 110 to support the inner pot 130. For example, the inner pot support member can support the outer circumferential surface of the inner pot 130 as well as the bottom surface of the inner pot 130. In this example, the side heating coil 160 may be disposed on the inner pot support member.

The side heating coil 160 may be vertically disposed. In some examples, the side heating coil 160 includes a plurality of layers corresponding to a number of turns thereof, and the layers of the side heating coil 160 may be vertically disposed side by side along the outer circumferential surface of the inner pot 130.

In some implementations, the side heating coil 160 may be electrically connected to the first power receiving coil 140a. For example, a first end of the side heating coil 160 may be connected to a first end of the first power receiving coil 140a. In this configuration, the first power receiving coil 140a and the side heating coil 160 may be configured as a single metal wire and the first power receiving coil 140a and the side heating coil 160 may be distinguished from each other by their positions and functions described herein.

Where the side heating coil 160 is electrically connected to the first power receiving coil 140a, current induced in the first power receiving coil 140a may flow through the side heating coil 160. The current flowing through the side heating coil 160 generates a magnetic field in the side heating coil 160, and the magnetic field generated in the side heating coil 160 induces the current in the outer circumferential surface of the inner pot 130, thereby heating the inner pot 130, such as a side surface of the inner pot 130.

In implementations where the first power receiving coil 140a is disposed below the edge area RA in which the heating coil provides a reduced amount of heat, or in which heat is not vertically transferred, the current induced by the heating coil 210 and generated in the side heating coil 160 can prevent a decrease in the total amount of heat generated at the inner pot 130.

In some examples, a number of turns of the side heating coil 160 may be greater than a number of turns of the first power receiving coil 140a to improve the efficiency in the heating operation.

As described with reference to FIGS. 4A and 4B, the first power receiving coil 140a can generate induction current and transmits the generated induced current to the side heating coil 160, while minimizing or preventing a decrease in the amount of heat generated at the inner pot 130.

Alternatively or in addition, the side heating coil 160 can be disposed and configured to heat a wider range of the outer circumferential surface of the inner pot 130 than the side heating coil 160 illustrated in FIGS. 4A and 4B. In some implementations, the first power receiving coil 140a may have a relatively narrow horizontal width in order to minimize a decrease in heat generation with respect to the inner pot 130, and the side heating coil 160 may have a relatively greater vertical width to surround the outer circumferential surface of the inner pot 130 in a wide range. Where the thicknesses of the metal wire of the first power receiving coil 140a is the same as the thickness of the side heating coil 160, a horizontal width of the first power receiving coil 140a and a vertical width of the side heating coil 160 may be proportional to a number of turns of the coils 140 and 160, respectively. In this example, the number of turns of the first power receiving coil 140a may be relatively less than the number of turns of the side heating coil 160 so that the width of the first power receiving coil 140a is relatively small while the width of the side heating coil 160 is relatively large.

According to some implementations of the present disclosure, the bottom surface of the inner pot as well as the side of the inner pot may be heated based on the magnetic field generated by the heating coil, and thus provide a plurality of heat transfer paths based on a single heat source and achieve temperature uniformity of the inner pot.

In some examples, where the first power receiving coil 140a and the side heating coil 160 are disposed to the inner pot 130 as described herein, an overall impedance value (|Z|) of the wireless induction heating cooker 100 may be a combination of an impedance value of the inner pot 130 and impedance values of the first power receiving coil 140a and the side heating coil 160. Accordingly, when the first power receiving coil 140a and the side heating coil 160 are used for the inner pot 130, the overall impedance value (|Z|) of the wireless induction heating cooker 100 is reduced, and an output of the heating coil 210 that is transmitted toward the inner pot 130 may also be reduced due to the reduction in the overall impedance value (|Z|). In order to prevent such output reduction, a second end of the first power receiving coil 140a and a second end of the side heating coil 160 may be electrically connected to each other through a resonance capacitor Cr. The first power receiving coil 140a, the side heating coil 160, and the resonance capacitor Cr may form an LC resonance circuit, and the LC resonance circuit may be magnetically coupled to the heating coil 210 based on a resonance frequency. In this case, as the overall impedance value (|Z|) of the wireless induction heating cooker 100 becomes a maximum impedance level, a maximum level of the output transmitted from the heating coil 210 toward the inner pot 130 may also be provided.

In some implementations, the power transmitting coil 150 may be provided at a side of the upper portion of the main body 110 to receive the current induced in the first power receiving coil 140a to generate the magnetic field.

Referring to FIG. 3, the power transmitting coil 150 may be supported by any suitable support member and fixedly disposed at a side of an upper portion of the main body 110. The power transmitting coil 150 may be disposed in contact with the side of the main body 110 to minimize the size of the wireless induction heating cooker 100.

In some examples, the power transmitting coil 150 may have a plate shape, and may be horizontally disposed at the side of the main body 110 to face the second power receiving coil 140b described below. That is, the power transmitting coil 150 may perpendicularly protrude from the side of the main body 110.

For example, the power transmitting coil 150 may be disposed along the outer surface of the main body 110 at the side of the upper portion of the main body 110.

Referring to FIG. 5, when the main body 110 has a cylindrical shape, the power transmitting coil 150 may be disposed along the outer circumferential surface of the main body 110 at the side of the upper portion of the main body 110. In some examples, the power transmitting coil 150 may be in contact with the outer circumferential surface of the main body 110 within a predetermined circular arc length. Accordingly, the power transmitting coil 150 may have a deformed elliptical shape such that a length of a major axis adjacent to the main body 110 is within a preset circular arc length.

Alternatively, when the main body 110 has a square pillar shape, the power transmitting coil 150 may be disposed along the outer surface of the main body 110 at the side of the upper portion of the main body 110. For example, the power transmitting coil 150 may have a rectangular shape such that a horizontal length adjacent to the main body 110 is within a preset length and may also have an elliptical shape such that a length of a long axis adjacent to the main body 110 is within a preset circular arc length.

The power transmitting coil 150 may be electrically connected to the first power receiving coil 140a. Because the power transmitting coil 150 is electrically connected to the first power receiving coil 140a, the current induced in the first power receiving coil 140a may flow through the power transmitting coil 150. Current flowing through the power transmitting coil 150 can generate a magnetic field.

In some examples, according to the present disclosure, the wireless induction heating cooker 100 may further include a first power conversion circuit 170 that transmits the current induced in the first power receiving coil 140a to the power transmitting coil 150.

Referring to FIGS. 2, 3, and 5, the first power conversion circuit 170 may be or include a packaged integrated circuit and may be provided at one side of the main body 110. In some examples, the first power conversion circuit 170 may be fixed to one side of the main body 110 below the power transmitting coil 150.

Referring to FIG. 6, an input terminal of the first power conversion circuit 170 may be connected to the first power receiving coil 140a, and an output terminal of the first power conversion circuit 170 may be connected to the power transmitting coil 150. Accordingly, the first power conversion circuit 170 may convert the current induced in the first power receiving coil 140a into stable alternating current (AC) and may provide the power transmitting coil 150 with the AC.

The amount of current induced in the first power receiving coil 140a may vary depending on the output of the heating coil 210 and a load amount of the inner pot 130 (e.g., moisture contained in the food and the amount of food). In some examples, the amount of current induced in the first power receiving coil 140a may vary depending on a relative position between the heating coil 210 and the wireless induction heating cooker 100 (e.g., a degree of positional matching between the heating coil 210 and the wireless induction heating cooker 100).

In order to minimize changes in the amount of current, the first power conversion circuit 170 stores the current induced in the first power receiving coil 140a as a predetermined voltage, converts the stored voltage into a stable AC current, and provides the power transmitting coil 150 with the stable AC. Accordingly, the power transmitting coil 150 may receive the AC of a predetermined frequency to generate a magnetic field.

In some implementations, the second power receiving coil 140b is provided at one side of the lid 120 and may provide at least one electronic device the current induced based on the magnetic field generated by the power transmitting coil 150.

Referring to FIG. 3, the second power receiving coil 140b may be supported by any suitable support member and fixedly disposed on one side of the lid 120. The second power receiving coil 140b may be in contact with the side surface of the lid 120 to minimize the size of the wireless induction heating cooker 100.

In some examples, the second power receiving coil 140b may have a plate shape similar to the power transmitting coil 150, and may be horizontally disposed at the side surface of the lid 120 to face the power transmitting coil 150. That is, the second power receiving coil 140b may perpendicularly protrude from the side surface of the lid 120.

In one example, the second power receiving coil 140b may be disposed along the outer surface of the lid 120 at one side of the lid 120.

Referring to FIG. 5, when the lid 120 has a cylindrical shape, the second power receiving coil 140b may be disposed along the outer circumferential surface of the lid 120 at one side of the lid 120. In some examples, the second power receiving coil 140b may be in contact with the outer circumferential surface of the lid 120 within a preset circular arc length. Accordingly, the second power receiving coil 140b may have a deformed elliptical shape such that the length of the long axis adjacent to the lid 120 is within a preset circular arc length.

Alternatively, where the lid 120 has a square pillar shape, the second power receiving coil 140b may be disposed along the outer surface of the lid 120 at one side of the lid 120. For example, the second power receiving coil 140b may have a rectangular shape such that a horizontal length adjacent to the lid 120 is within a preset length and may also have an elliptical shape such that the length of the long axis adjacent to the lid 120 is within the predetermined circular arc length.

In some examples, the second power receiving coil 140b may be provided at one side of the lid 120 and at a position corresponding to the power transmitting coil 150.

Induced current may be generated by the second power receiving coil 140b based on a magnetic field generated by the power transmitting coil 150. In order to maximize the amount of current generated by the second power receiving coil 140b, the second power receiving coil 140b may be provided at a position corresponding to the position of the power transmitting coil 150. In some examples, the second power receiving coil 140b may face the power transmitting coil 150 at a position that permits for the second power receiving coil 140b to be magnetically coupled to the power transmitting coil 150 with a maximum coupling factor.

In one example, the second power receiving coil 140b may be vertically overlapped with the power transmitting coil 150.

In some examples, at least a portion of the second power receiving coil 140b may be completely overlapped with the power transmitting coil 150. In other words, when the wireless induction heating cooker 100 is viewed from top, a portion or the entire area of the second power receiving coil 140b may be included in an area formed by the power transmitting coil 150. In some implementations, in order for the second power receiving coil 140b and the power transmitting coil 150 to be magnetically coupled with the maximum coupling factor, the second power receiving coil 140b may be entirely included in an area formed by the power transmitting coil 150.

Referring to FIG. 5, in some implementations, the second power receiving coil 140b and the power transmitting coil 150 may have the same size and shape. In this case, the second power receiving coil 140b may be completely overlapped with the power transmitting coil 150 vertically. In other words, the second power receiving coil 140b and the power transmitting coil 150 have the same size and shape and may be spaced apart from each other by a predetermined vertical distance at a same horizontal position. For example, the second power receiving coil 140b may be disposed in the lid 120, and the power transmitting coil 150 may be disposed in the main body 110.

In other implementations, the area of the second power receiving coil 140b may be less than the area of the power transmitting coil 150. In this case, the second power receiving coil 140b may be completely included in an area formed by the power transmitting coil 150 vertically. In some examples, as shown in FIG. 5, where the second power receiving coil 140b and the power transmitting coil 150 each have the deformed elliptical shape such that the center of the circular arc of the second power receiving coil 140b with respect to a major axis of the second power receiving coil 140b is the same as that of the power transmitting coil 150, a length of the major axis of the second power receiving coil 140b may be less than a length of a major axis of the power transmitting coil 150.

The above-described structural features allow the maximum amount of current to be induced in the second power receiving coil 140b, and the second power receiving coil 140b may provide the induced current to the electronic device inside the lid 120.

Referring to FIG. 6, the second power receiving coil 140b may be electrically connected to a plurality of electronic devices inside the lid 120. Accordingly, the plurality of electronic devices may receive the induced current generated in the second power receiving coil 140b as a power source.

The plurality of electronic devices may operate based on a power supply provided by the second power receiving coil 140b. For example, the controller 121 controls the overall operation of the wireless induction heating cooker 100 (e.g., the steam discharge and blockage operation of the steam discharger 124) based on the power received from the second power receiving coil 140b. In some examples, the communicator 122 may perform data communication with the communicator 240 of the induction heating device based on the power received from the second power receiving coil 140b. In some examples, the display 123 may visually output state information related to the wireless induction heating cooker 100 based on the power received from the second power receiving coil 140b.

In some examples, as shown in FIG. 6, the wireless induction heating cooker 100 may further include a second power conversion circuit that transmits the current induced in the second power receiving coil 140b to one or more of the plurality of electronic devices in the lid 120.

Referring to FIGS. 2 and 3, the second power conversion circuit 180 may be or include the packaged integrated circuit and may be provided in the lid 120. Referring back to FIG. 6, an input terminal of the second power conversion circuit 180 may be connected to the second power receiving coil 140b, and an output terminal of the second power conversion circuit 180 may be connected to each electronic device in the lid 120. Accordingly, the second power conversion circuit 180 may convert the current induced in the second power receiving coil 140b into the stable DC voltage, and provide the same to each electronic device.

In some examples, an AC may be induced in the second power receiving coil 140b. In some examples, each electronic device may receive, and be operated with, the DC voltage, as a power source, that has the predetermined magnitude according to specification.

The second power conversion circuit 180 converts the current induced in the second power receiving coil 140b into the DC voltage, and store the DC voltage. The second power conversion circuit 180 can boost or drop the stored DC voltage to output a DC voltage having the predetermined magnitude that meets the specification of each electronic device. The second power conversion circuit 180 can transmit such adjusted DC voltage to each of electronic devices. Accordingly, each electronic device (e.g., the controller 121, the communicator 122, the display 123, etc.) may operate based on the DC voltage suitable for specification of each electronic device itself.

According to the present disclosure, the wireless induction heating cooker can wirelessly receive the power from the induction heating device, and perform the cooking operation (e.g., perform heating the food) and other operations for user convenience without connection with an external power supply and an internal battery.

In some examples, referring to FIG. 6, the wireless induction heating cooker 100 of the present disclosure may further include a battery 190 that stores current induced in the second power receiving coil 14.

The battery 190 may be disposed in the lid 120 and configured to store current induced in the second power receiving coil 140b as a reserve power. The second power conversion circuit 180 may operate to charge the battery 190 by controlling the magnitude of the current induced in the second power receiving coil 140b.

The battery 190 may be electrically connected to one or more of the plurality of electronic devices inside the lid 120, and each connected electronic device may operate by receiving power from the battery 190. In some examples, one or more of the plurality of electronic devices can operate based on the DC voltage output from the second power conversion circuit 180. When the DC power is not provided from the second power conversion circuit 180, one or more of the electronic devices may operate by receiving the DC voltage from the battery 190.

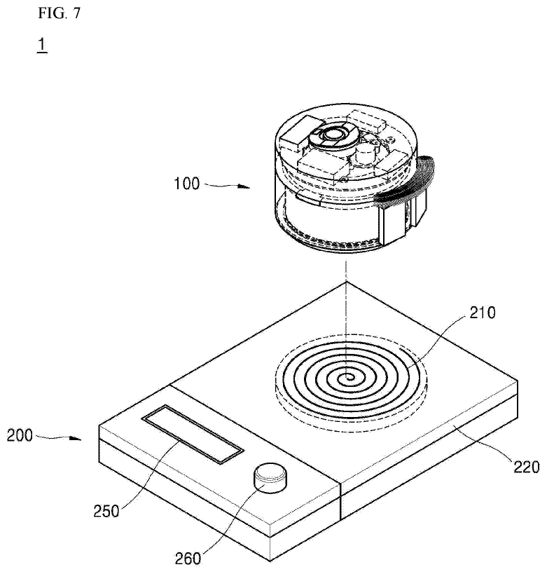

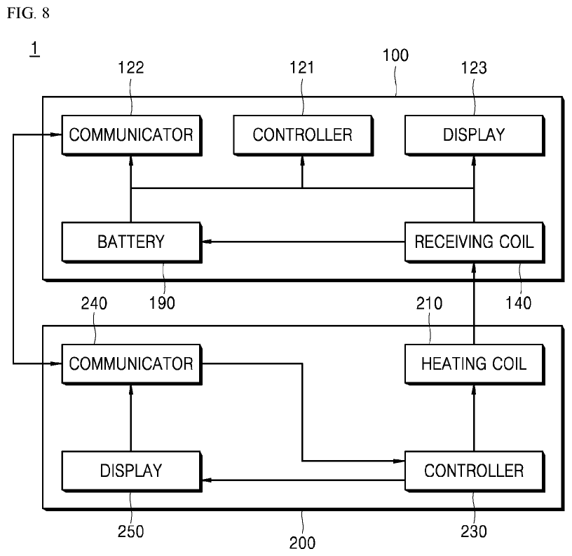

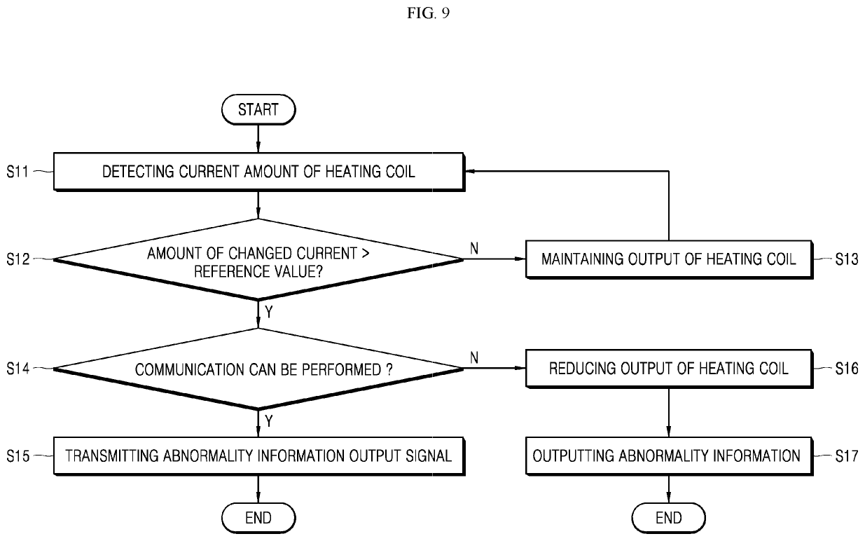

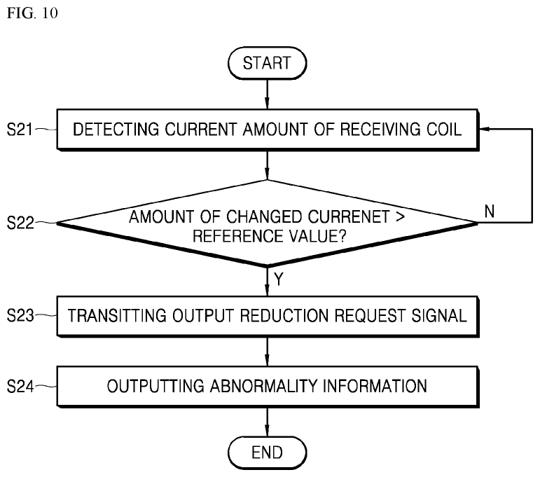

A wireless induction heating system according to some implementations of the present disclosure is described in detail with reference to FIGS. 7 to 10. FIG. 7 shows an example wireless induction heating system. FIG. 8 shows an example control flow of the wireless induction heating system shown in FIG. 7. FIG. 9 is a flow chart showing an example operation of an induction heating device 200. FIG. 10 is a flow chart showing an example operation process of the wireless induction heating cooker 100.

Referring to FIG. 7, an example wireless induction heating system may include an induction heating device 200 and a wireless induction heating cooker 100 that operates on the induction heating device 200. The induction heating device 200 and the wireless induction heating cooker 100 of the wireless induction heating system can be configured similarly to those described with reference to FIGS. 2 to 6. Described below are primarily differences from those described in FIGS. 2-6.

The induction heating device 200 may generate a magnetic field through the heating coil 210, and the wireless induction heating cooker 100 may be disposed in an area formed by the heating coil 210 and may be operated using the magnetic field generated by the heating coil 210.

The area formed by the heating coil 210 may be a minimum area that may include all portions of the heating coil 210. For example, where the heating coil 210 is a circular plate coil, the area of the region formed by the heating coil 210 may be a circle having a coil radius that corresponds to a distance between the center of the heating coil 210 and the outer circumferential surface of the heating coil 210.

Referring to FIGS. 7 and 8, in some implementations, the induction heating device 200 may include a heating coil 210, a controller 230, a communicator 240, a display 250, and a knob switch 260. The induction heating device 200 may include additional components with or without one or more of the illustrated components of the induction heating device 200 being modified or removed.

The controller 230 may control the heating coil 210 and the display 250. In some examples, the controller 230 may control the output of the heating coil 210 and the display 250 may control to output the state information related to the induction heating device 200. Further, the display 250 can output abnormality information described below.

The knob switch 260 may be provided on the upper surface of the induction heating device 200 and configured to transmit a signal to the controller 230 based on a degree of rotation thereof. The controller 230 may determine the output of the heating coil 210 based on the signal received from the knob switch 260. In other words, the output of the heating coil 210 may be controlled based on the degree of rotation of the knob switch 260.

In some examples, the wireless induction heating cooker 100 may be placed and operated in the area formed by the heating coil 210. In some examples, the area formed by the bottom surface of the wireless induction heating cooker 100 may be positioned in the area formed by the heating coil 210.

The wireless induction heating cooker 100 may perform cooking operation based on the magnetic field generated by the heating coil 210. The cooking operation of the wireless induction heating cooker 100 may include heating the food by heating the inner pot. In addition, the cooking operation can include overall operations of the controller 121, communicator 122, display 123, and other suitable components in the wireless induction heating cooker 100.

The induction heating device 200 and the wireless induction heating cooker 100 can perform mutual data communication based on a displacement state of the wireless induction heating cooker 100 with respect to the induction heating device 200. Such mutual data communication between the induction heating device 200 and the wireless induction heating cooker 100 can control output of the heating coil 210, and output abnormality information.

For example, the displacement state of the wireless induction heating cooker 100 may include a normal displacement state and an abnormal displacement state.

In one example, when a horizontal distance between the center vertical line of the heating coil 210 and the center vertical line of the wireless induction heating cooker 100 is within a predetermined distance, the displacement state of the wireless induction heating cooker 100 may be a normal displacement state. When the horizontal distance between the center vertical line of the heating coil 210 and the center vertical line of the wireless induction heating cooker 100 exceeds a preset distance, the displacement state of the wireless induction heating cooker 100 may be an abnormal displacement state.

Alternatively or in addition, when the area formed by the bottom surface of the wireless induction heating cooker 100 is entirely included in the area formed by the heating coil 210, the displacement state of the wireless induction heating cooker 100 may be a normal displacement state. When the area formed by the bottom surface of the wireless induction heating cooker 100 is not entirely included in the area formed by the heating coil 210, the displacement state of the wireless induction heating cooker 100 may be in an abnormal displacement state.

The induction heating device 200 and the wireless induction heating cooker 100 can perform data communication based on the displacement state of the wireless induction heating cooker 100. One or both of the induction heating device 200 and the wireless induction heating cooker 100 may output abnormality information. In some examples, the induction heating device 200 may control the output of the heating coil 210 based on the displacement state.

The abnormality information may include any information indicating that the wireless induction heating cooker 100 is not properly disposed relative to the induction heating device 200. The abnormality information can be of various format, such as visual or audible information. For example, the abnormality information may include text and voice information to request the user to change the position of the wireless induction heating cooker 100.

An example operation of the induction heating device 200 based on the displacement state of the wireless induction heating cooker 100 is described below.

The induction heating device 200 may determine the displacement state of the wireless induction heating cooker 100 based on a change in the amount of current through the heating coil 210. For example, referring to FIG. 8, the controller 230 may detect an amount of current through the heating coil 210. Any suitable current sensor or current detection circuit may be used so that the controller 230 can detect the amount of current through the heating coil 210. The controller 230 may detect the amount of current through the heating coil 210 during a preset period of time and may calculate a change in the amount of current between a previous period of time and the current period of time. The controller 230 can perform such detection and calculation for every period of time.

Various external factors can cause a position of the wireless induction heating cooker 100 to change from the normal displacement state, so that the displacement state of the wireless induction heating cooker 100 changes from the normal displacement state to the abnormal displacement state.

When the displacement state of the wireless induction heating cooker 100 changes to the abnormal displacement state, the degree that the heating coil 210 matches the wireless induction heating cooker 100 is reduced, and the amount of current through the heating coil 210 may also be reduced. Accordingly, the controller 230 may determine the displacement state of the wireless induction heating cooker 100 by comparing a change in the amount of current through the heating coil 210 with a reference value. For example, the controller 230 may determine the displacement state of the wireless induction heating cooker 100 to be the normal displacement state when a change in the amount of current through the heating coil 210 is less than or equal to the reference value. The controller 230 may determine the disposition state of the wireless induction heating cooker 100 to be the abnormal displacement state if a change in the amount of current through the heating coil 210 exceeds the reference value.

According to the present disclosure, the wireless induction heating system determines whether the wireless induction heating cooker is normally disposed on the induction heating device and determine an abnormal displacement state of the wireless induction heating cooker, which causes degradation in cooking performance without the user's recognition.

The induction heating device 200 may maintain the output of the heating coil 210 when the displacement state of the wireless induction heating cooker 100 is the normal displacement state. When the displacement state of the wireless induction heating cooker 100 is the abnormal displacement state, the output of the heating coil 210 may be reduced.

In some examples, when the displacement state of the wireless induction heating cooker 100 is the normal displacement state, the controller 230 may not additionally control the heating coil 210. Accordingly, the output of the heating coil 210 may be maintained without change. When the displacement state of the wireless induction heating cooker 100 is the abnormal displacement state, the controller 230 controls an inverter of the induction heating device 200 to reduce the magnitude of the current supplied to the heating coil 210. Accordingly, the output of the heating coil 210 may be reduced.

In some examples, the induction heating device 200 determines the communication state with the wireless induction heating cooker 100 based on the displacement state of the wireless induction heating cooker 100 being the abnormal displacement state, and outputs abnormality information or may control the wireless induction heating cooker 100 to output the abnormality information based on the determined communication state.

Referring to FIG. 8, the wireless induction heating cooker 100 may perform data communication with the induction heating device 200 based on current induced by a magnetic field generated by the heating coil 210.

In some examples, the wireless induction heating cooker 100 may include a receiving coil 140 in which the current is induced based on the magnetic field generated by the heating coil 210. The wireless induction heating cooker 100 may operate the communicator 122 based on the current induced in the receiving coil 140. The receiver may be at least one of the first power receiving coil 140a and the second power receiving coil 140b described with reference to FIGS. 2 to 6.

The communicator 122 of the wireless induction heating cooker 100 can operate based on current induced in the receiving coil 140 as a power source. The communicator 122 may operate only using the current induced in the receiving coil 140. Accordingly, the communicator 122 may perform data communication at a high communication rate when the displacement state of the wireless induction heating cooker 100 is the normal displacement state.

The communicator 240 of the induction heating device 200 may transmit a communication request signal to the communicator 122 of the wireless induction heating cooker 100 when the displacement state of the wireless induction heating cooker 100 is the abnormal displacement state. The communicator 122 of the wireless induction heating cooker 100 may generate a communication response signal corresponding to the communication request signal and may transmit the generated communication response signal to the communicator 240 of the induction heating device 200.

Even when the displacement state of the wireless induction heating cooker 100 is the abnormal displacement state, the communicator 122 can be operated based on the current induced in the receiving coil 140, and may transmit the communication response signal to the communicator 240.

The induction heating device 200 may determine a state of communication with the wireless induction heating cooker 100 based on whether the communication response signal is received. In some examples, the induction heating device 200 may determine the communication state as the normal state when the communication response signal is received from the wireless induction heating cooker 100, and may determine the communication state as an unable state when the communication response signal is not received from the induction heating cooker 100.

The induction heating device 200 may control the wireless induction heating cooker 100 to output abnormality information based on determination of the communication state. For example, when the displacement state of the wireless induction heating cooker 100 is the abnormal displacement state and the communication state is the normal state, the communicator 240 may transmit an abnormality information output request signal to the communicator 122. The controller 121 of the wireless induction heating cooker 100 may receive the abnormality information output request signal through the communicator 122 and may control the display 123 to visually output the abnormality information to the user based on the received signal.

In some examples, the induction heating device 200 may reduce the output of the heating coil 210 and may output the abnormality information based on the determination that the communication state thereof is the unable state. For example, when the displacement state of the wireless induction heating cooker 100 is the abnormal displacement state and the communication state is the unable state, data communication does not occur, and the communicator 240 may not transmit the abnormality information output request signal to the communicator 122. In this case, the controller 230 may reduce the output of the heating coil 210 by reducing the amount of current supplied to the heating coil 210, and may control the display 250 to visually output the abnormality information to the user.

According to the present disclosure, the wireless induction heating system may notify users of the abnormally disposed wireless induction heating cooker and induction heating device so that the user can properly dispose the wireless induction heating cooker on the induction heating device. Further, the degradation in the rice-cooking performance caused by the poor displacement of the wireless induction heating cooker can be prevented.

Described below is an example operation of the wireless induction heating cooker 100 that is determined based on the displacement state of the wireless induction heating cooker 100.

The wireless induction heating cooker 100 may determine the displacement state of the wireless induction heating cooker 100 based on a change in the amount of current through the receiving coil 140.

Referring to FIG. 8, the controller 121 may detect the current amount of the receiving coil 140. Any suitable current sensor or current detection circuit may be used so that the controller 121 can detect the current amount of the receiving coil 140. The controller 121 may detect the amount of current through the receiving coil 140 during a preset period of time and calculate a change in the amount of current between the previous period of time and the current period of time. The controller 121 can perform such detection and calculation for every periods of time.

When the displacement state of the wireless induction heating cooker 100 changes from the normal displacement state to the abnormal displacement state, the degree that the heating coil 210 matches the receiving coil 140 is reduced, the amount of current through the receiving coil 140 may also be reduced. Accordingly, the controller 121 may determine the displacement state of the wireless induction heating cooker 100 by comparing a change in the amount of current of the receiving coil 140 with a reference value. For example, the controller 121 may determine the displacement state of the wireless induction heating cooker 100 to be the normal displacement state when a change in the amount of current through the receiving coil 140 is less than or equal to the reference value. The controller 121 may determine the displacement state of the wireless induction heating cooker 100 to be the abnormal displacement state when a change in the amount of current through the receiving coil 140 exceeds the reference value.

Based on the determination that the displacement state of the wireless induction heating cooker 100 is the abnormal displacement state, the controller 121 may control the display 123 to visually output the abnormal signal to the user.

In some examples, the wireless induction heating cooker 100 may transmit an output reduction request signal to the induction heating device 200 based on the determination that the displacement state of the wireless induction heating cooker 100 is the abnormal displacement state. The induction heating device 200 may reduce the output of the heating coil 210 based on the output reduction request signal.

In some examples, based on the displacement state of the wireless induction heating cooker 100 being the abnormal displacement state, the communicator 122 may transmit an output reduction request signal to the communicator 240 of the induction heating device 200.

When the communicator 122 operates based on the current induced in the receiving coil 140 as a power source, and the displacement state of the wireless induction heating cooker 100 is the abnormal displacement state and the communication state is the unable state, the output reduction request signal may not be transmitted to the communicator 240. When the displacement state of the wireless induction heating cooker 100 is the abnormal displacement state and the communication state is the normal state, the output reduction request signal may be transmitted to the communicator 240. The controller 230 may receive the output reduction request signal through the communicator 240 and may reduce the current amount supplied to the heating coil 210 based on the received signal.

In some examples, the communicator 122 of the wireless induction heating cooker 100 may receive the power from the internal battery 190 in order for the output reduction request signal to be transmitted to the induction heating device 200 even when the displacement state of the wireless induction heating cooker 100 is the abnormal displacement state and the communication state thereof is the unable state.

Referring to FIG. 8, the wireless induction heating cooker 100 may further include a battery 190. The battery 190 may be a non-rechargeable battery that supplies a predetermined voltage or a rechargeable battery that stores the current induced in the receiving coil 140 as the reserve power.

The battery 190 may supply a predetermined voltage to the communicator 122 regardless of whether the current is induced in the receiving coil 140. Accordingly, the wireless induction heating cooker 100 may transmit an output reduction request signal to the induction heating device 200 through the communicator 122 that receives the power from the battery 190.

In this case, the output of the heating coil 210 may be reduced in all cases where the displacement state of the wireless induction heating cooker 100 is the abnormal displacement state.

Referring to FIGS. 9 and 10, an example operation process of the induction heating device 200 and the wireless induction heating cooker 100 is described below.

Referring to FIG. 9, the induction heating device 200 may detect an amount of current through the heating coil 210 (S11) and may calculate a change in an amount of current between a previous period of time and the current period of time, and may compare the calculated change in the amount of current with a reference value (S12).

When the change in the amount of current is equal to or less than the reference value, the induction heating device 200 may maintain the output of the heating coil 210 by maintaining the amount of current supplied to the heating coil 210 (S13). When the change in the amount of current exceeds the reference value, the induction heating device 200 may determine whether the communication with the wireless induction heating cooker 100 can be performed (S14).

Based on the determination that the communication may be performed (i.e. in a normal state), the induction heating device 200 may transmit an abnormality information output signal to the wireless induction heating cooker 100 (S15).

The determination of whether the communication may be performed (i.e. in a communication state) through a process of transmitting the communication request signal and receiving the communication response signal can be performed by the process described herein. Further, the process of operating the wireless induction heating cooker 100 based on the abnormality information output signal can be performed by the process described herein.

Based on the determination that the communication cannot be performed (i.e., in the unable state), the induction heating device may reduce the output of the heating coil 210 by reducing the amount of current supplied to the heating coil 210 (S16).

Subsequently, the induction heating device may visually output the abnormality information to the user through the internal display 250 (S17). In some examples, the sequence of S16 and S17 may be reversed.

Referring to FIG. 10, the wireless induction heating cooker 100 may detect a current amount of the receiving coil 140 (S21), may calculate a change in the amount of current of the receiving coil 140 between a previous period of time and the current period of time, and may compare the calculated change in the amount of current with a reference value (S22).

Based on the change in the amount of current being equal to or less than the reference value, the operation of S21 and S22 may be continually and repeatedly performed. Based on the change in the amount of current exceeding the reference value, an output reduction request signal may be transmitted to the induction heating device 200 (S23).

The process of operating the induction heating device 200 based on the output reduction request signal can be performed similarly or identically to the process described above.

After the output reduction request signal is transmitted, the wireless induction heating cooker 100 may visually output the abnormality information to the user through the internal display 123 (S24). In some examples, the sequence of S23 and S24 may be reversed.

According to the present disclosure, the wireless induction heating system may control the amount of transferred heat with respect to the wireless induction heating cooker based on the mutual displacement between the wireless induction heating cooker and the induction heating device, so that a safety problem that would result from a poor displacement of the wireless induction heating cooker can be prevented.

Various substitutions, modifications, and changes can be made by a person skilled in the art to which the present disclosure pertains within the scope that does not deviate from the technical idea of the present disclosure. A person skilled in the art can further recognize that the present disclosure is not limited to the above-mentioned implementations and the accompanying drawings.

What is claimed is:

1. A wireless induction heating system, comprising:
an induction heating device including a heating coil defining a heating area and configured to generate a magnetic field; and
a wireless induction heating cooker configured to be positioned on the heating area of the induction heating device, and configured to perform a cooking operation using the magnetic field generated by the heating coil,
wherein the induction heating device and the wireless induction heating cooker are configured to perform data communication with each other and control output of the heating coil based on a position of the wireless induction heating cooker relative to the induction heating device, and
wherein the induction heating device and the wireless induction heating cooker are configured to output abnormality information based on the position of the wireless induction heating cooker being an abnormal position.

2. The wireless induction heating system of claim 1, wherein the induction heating device is configured to determine a displacement state of the wireless induction heating cooker based on a change in an amount of current through the heating coil.

3. The wireless induction heating system of claim 2, wherein, based on the change in the amount of current through the heating coil being equal to or less than a reference value, the induction heating device determines the displacement state of the wireless induction heating cooker to be a normal displacement state,
wherein, based on the change in the amount of current through the heating coil exceeding the reference value, the induction heating device determines the displacement state of the wireless induction heating cooker to be an abnormal displacement state.

4. The wireless induction heating system of claim 2, wherein the induction heating device is configured, based on the displacement state of the wireless induction heating cooker being a normal displacement state, to maintain the output of the heating coil, and
wherein the induction heating device is configured, based on the displacement state of the wireless induction heating cooker being an abnormal displacement state, to reduce the output of the heating coil.

5. The wireless induction heating system of claim 1, wherein the wireless induction heating cooker is configured to perform the data communication with the induction heating device based on current induced by the magnetic field generated by the heating coil.

6. The wireless induction heating system of claim 5, wherein the induction heating device is configured to determine a communication state with the wireless induction heating cooker based on the wireless induction heating cooker being an abnormal displacement state relative to the induction heating device, and
wherein the induction heating device is configured to generate abnormality information and control the wireless induction heating cooker to output the abnormality information based on the communication state with the wireless induction heating cooker.

7. The wireless induction heating system of claim 6, wherein the wireless induction heating cooker is configured, based on the communication state between the induction heating device and the wireless induction heating cooker being a normal state, to output the abnormality information, and
wherein the induction heating device is configured, based on the communication state between the induction heating device and the wireless induction heating cooker being an unable state, to reduce the output of the heating coil and output the abnormality information.

8. The wireless induction heating system of claim 1, wherein the wireless induction heating cooker comprises a receiving coil in which current is induced based the magnetic field generated by the heating coil, and wherein the wireless induction heating cooker is configured to determine a displacement state of the wireless induction heating cooker relative to the induction heating device based on a change in an amount of current through the receiving coil.

9. The wireless induction heating system of claim 8, wherein, based on the change in the amount of current through the receiving coil being equal to or less than a reference value, the wireless induction heating cooker determines the displacement state of the wireless induction heating cooker to be a normal displacement state, and
wherein, based on the change in the amount of current through the receiving coil exceeding the reference value, the wireless induction heating cooker determines the displacement state of the wireless induction heating cooker to be an abnormal displacement state.

10. The wireless induction heating system of claim 8, wherein the wireless induction heating cooker is configured to output an abnormal signal based on the displacement state of the wireless induction heating cooker being an abnormal displacement state.

11. The wireless induction heating system of claim 8,
wherein the wireless induction heating cooker is configured to transmit an output reduction request signal to the induction heating device based on the displacement state of the wireless induction heating cooker being an abnormal displacement state, and
wherein the induction heating device is configured to reduce the output of the heating coil based on the output reduction request signal.

12. The wireless induction heating system of claim 11, wherein the wireless induction heating cooker includes a communicator and an internal battery configured to supply power to the communicator, wherein the wireless induction heating cooker is configured to transmit the output reduction request signal to the induction heating device through the communicator.

13. A wireless induction heating cooker, the wireless induction heating cooker configured to operate on an induction heating device having a heating coil, the wireless induction heating cooker comprising:
a main body having an upper surface defining an opening;
a lid configured to cover the upper surface of the main body and including a plurality of electronic devices;
an inner pot received in the main body and heated using a first magnetic field generated by the heating coil of the induction heating device;
a first power receiving coil disposed on a bottom surface of the main body, wherein current is induced in the first power receiving coil based on the first magnetic field generated by the heating coil;
a side heating coil disposed around an outer side surface of the inner pot, the side heating coil being connected to the first power receiving coil and configured to heat the inner pot based on the current induced in the first power receiving coil;
a power transmitting coil disposed at a side of the main body and configured to receive the current induced in the first power receiving coil and generate a second magnetic field;
a second power receiving coil disposed at a side of the lid and configured to supply a current to one or more of the plurality of electronic devices, the current being induced by the second magnetic field generated by the power transmitting coil;
a controller configured to determine an displacement state of the wireless induction heating cooker relative to the induction heating device based on a change in an amount of current through at least one of the first power receiving coil and the second power receiving coil; and
a communicator configured to perform data communication with the induction heating device based on the displacement state of the wireless induction heating cooker.

14. The wireless induction heating cooker of claim 13, wherein the controller and the communicator are configured to operate based on the current induced in the second power receiving coil.

15. The wireless induction heating cooker of claim 13, wherein the controller is configured to, based on the change in the amount of current being equal to or less than a reference value, determine the displacement state of the wireless induction heating cooker as a normal displacement state, and
wherein, the controller is configured to, based on the change in the amount of current exceeding the reference value, determine the displacement state of the wireless induction heating cooker as an abnormal displacement state.

16. The wireless induction heating cooker of claim 13, wherein the controller is configured to visually output abnormality information based on determination that the displacement state of the wireless induction heating cooker is the abnormal displacement state.

17. The wireless induction heating cooker of claim 13,
wherein the communicator is configured to transmit an output reduction request signal to the induction heating device based on determination that displacement state of the wireless induction heating cooker is an abnormal displacement state, and
wherein the induction heating device is configured to reduce the output of the heating coil based on the output reduction request signal.

18. The wireless induction heating cooker of claim 17, wherein the communicator is configured to transmit the output reduction request signal based on the current induced in the second power receiving coil or power supplied by an internal battery.

19. The wireless induction heating cooker of claim 13,
wherein the communicator is configured to receive an abnormality information output request signal from the induction heating device based on determination that the displacement state of the wireless induction heating cooker is an abnormal displacement state, and
wherein the controller is configured to visually output abnormality information based on the abnormality information output request signal.

20. The wireless induction heating cooker of claim 13, wherein the one or more of the plurality of electronic devices includes the controller and the communicator, and are disposed at the lid.
